(19) United States
(12) Patent Application Publication
(10) Pub. No.: US 2026/0024349 A1
(43) Pub. Date: Jan. 22, 2026

(54) SYSTEMS AND METHODS FOR DETECTING LAW ENFORCEMENT VEHICLES

(71) Applicant: Richard A. Giambruno, II, Parker, CO (US)

(72) Inventor: Richard A. Giambruno, II, Parker, CO (US)

(21) Appl. No.: 18/776,642

(22) Filed: Jul. 18, 2024

(51) Int. Cl. G06V 20/58; G06V 10/774; G08G 1/017; G08G 1/0967

(52) U.S. Cl. CPC G06V 20/58; G06V 10/774; G06V 2201/08; G08G 1/0175; G08G 1/096766

(57) ABSTRACT

Implementations disclosed herein may facilitate detection of law enforcement vehicles using machine learning models. Such machine learning models may be trained using images known to contain depictions of law enforcement vehicles, and/or images known to not contain depictions of law enforcement vehicles. The machine learning modules may be facilitated in use by a processor, and images may be taken from a camera, onboard a user vehicle.

### FIELD OF THE DISCLOSURE

The present invention relates to methods, computing systems, and storage media for detecting law enforcement vehicles.

### BACKGROUND

It is a hallmark of many constitutional systems, including the American constitutional system, that an individual is aware of the laws under which they are to abide, as well as of unwarranted or potentially unlawful observations of the individual by the government. For example, in many jurisdictions an unlawful vantage point may impact the validity of finding an infraction or violation. Thus, a driver of a vehicle may desire to know when being observed by law enforcement, just as an individual may desire to know whether they are under observation in other private locations, particularly when there is no warrant involved.

Oftentimes, a driver may desire to be able to determine the presence of a law enforcement vehicle. The law enforcement vehicle may be, for example, parked alongside a highway, in a parking lot, in a U-turn zone, or among many other places. The law enforcement vehicle may be located for a purpose of catching potential traffic infractions, watching for license plates associated with wanted vehicle registrants, or for various other purposes. In any event, the law enforcement vehicle may be parked openly or in a concealed manner.

Conventional solutions of detecting the presence of law enforcement vehicles have relied on, for example, human visual observation, human reporting, radar detectors, and laser detectors. Human observation relies upon a driver's ability to observe a law enforcement vehicle while the driver is driving along the highway. This can require the driver to take the driver's eyes off the focus of the road. Also, a driver may not see or notice the law enforcement vehicle. When the driver sees a suspected law enforcement vehicle, the driver may be inclined to study the suspected law enforcement vehicle, thus further keeping the driver's eyes off the road. Also, human observation is prone to human error, making this type of alerting inaccurate and unreliable.

Conventional electronic systems, including radar detectors and laser detectors, attempt to solve shortcomings of the visual detection method. For example, radar detectors function to alert the driver when the radar detector detects an emission of electromagnetic radiation from a radar device used by a law enforcement officer. A laser detector may similarly alert a driver when the laser range finder detects an emission of electromagnetic radiation, typically infrared radiation, from a law enforcement officer-operated laser device. Both electronic detection methods suffer shortcomings, including a requirement for the device to receive an emission of electromagnetic radiation to detect a position of the law enforcement vehicle. Such an emission may or may not be present, as law enforcement officers may not be operating devices emitting electromagnetic radiation in the direction of a particular vehicle. Furthermore, such systems are easily defeated by, for example, laws prohibiting their use as well as use of advanced detection systems by law enforcement officers designed to defeat such systems.

Yet another conventional solution includes a crowd-based reporting system, which plots the last-observed location of a law enforcement vehicle. However, such systems rely upon accurate user reporting, external computing, and suffer from the problem of untimely data (e.g., the last-observed location may be out-of-date).

A further defensive technical solution includes a radar jammer, although they are illegal in most countries. A radar jammer functions to attenuate, alter, or scramble a return signal originally emitted by a radar detection device. For example, a vehicle traveling may be the target of a radar detection system operating on a given frequency, and a radar jamming system may function to attenuate a return signal on that frequency. However, even such a defensive conventional solution requires incoming electromagnetic radiation to be effective. Without such incoming electromagnetic radiation, there is no way for any of these systems to determine the presence of a law enforcement vehicle in a given location.

Conventional electronic methods of detecting law enforcement vehicles thus require inbound, active electromagnetic radiation, emitted from a counterpart law enforcement device, to operate. Such systems require components capable of detection, and the operation of a device external to the user vehicle seeking to detect the presence of a law enforcement vehicle.

### SUMMARY

One aspect of the present disclosure relates to a method in a data processing system for detecting a law enforcement vehicle. The method may include, using a processor of the data processing system, receiving a digital image, at the processor, from a camera in electronic communication with the processor. The camera may be disposed within a user vehicle. The method may further include detecting, by the processor using a trained machine learning model, the law enforcement vehicle within the digital image. The trained machine learning model may be trained by training data including images of law enforcement vehicles. The method may further include transmitting, by the processor, a notification instruction to a notification output device disposed within the user vehicle indicating a law enforcement vehicle was detected.

Another aspect of the present disclosure relates to a computing system configured for detecting a law enforcement vehicle. The computing system includes a memory having executable instructions and one or more hardware processors configured to execute the instructions. The processor(s) may execute the instructions to receive a digital image from a camera in electronic communication with the processor.

The camera may be disposed within a user vehicle. The processor(s) may further execute the instructions to detect, using a trained machine learning model, the law enforcement vehicle within the digital image. The trained machine learning model may be trained by training data including images of law enforcement vehicles. The processor(s) may further execute the instructions to transmit a notification instruction to a notification output device disposed within the user vehicle indicating a law enforcement vehicle was detected.

### BRIEF DESCRIPTION OF THE DRAWINGS

FIG. 1A illustrates an example detection module, in accordance with one or more implementations.

FIG. 1B illustrates an example camera assembly, in accordance with one or more implementations.

FIG. 1C illustrates an example processor assembly, in accordance with one or more implementations.

FIG. 1D illustrates an example block diagram of a operations sequence, in accordance with one or more implementations.

FIG. 1E illustrates an alternative extension to the processor operation sequence illustrated in FIG. 1D, in accordance with one or more implementations.

FIG. 2 illustrates an operational environment, in accordance with one or more implementations.

FIG. 3 illustrates an example computer system to implement the processes, in accordance with one or more implementations.

FIG. 4 illustrates an artificial neural network (ANN), in accordance with one or more implementations.

FIG. 5 illustrates a node, in accordance with one or more implementations.

FIG. 6 illustrates a flow chart of a method of training a machine learning model of a machine learning module, in accordance with one or more implementations.

FIG. 7 illustrates a flow chart of a method of analyzing input data using a machine learning module, in accordance with one or more implementations.

FIG. 8 is a flow chart of a method for detecting a law enforcement vehicle, in accordance with one or more implementations.

### DETAILED DESCRIPTION

Implementations described herein provide for detection of law enforcement vehicles using electronic visual recognition in real-time of law enforcement vehicles while a vehicle is being driven on a road, in one implementation, using machine learning in images collected in real-time. For example, such implementations enable the onboard collection and processing of images of potential law enforcement vehicles on the road and alleviate the need to utilize external computing resources to perform the object detection. Furthermore, such a system may be integrated with a vehicle's existing systems, or may be an aftermarket add-on to an existing vehicle lacking the necessary integrating systems.

The system may include a camera device, as well as a computing device and may further contain a notification device or an ability to connect to an external notification device, for example, a speaker, a light, a mobile device, or another system capable of providing a notification to a driver of a vehicle.

Implementations herein provide advantages over—and overcome the shortcomings of—conventional solutions for detecting law enforcement vehicles. By employing implementations herein, beyond reducing error, a driver may be able to maintain focus on the road, be automatically notified of the presence of law enforcement vehicles the driver would otherwise not have discovered, and not need to study the suspected law enforcement vehicle. Further, implementations eliminate the need to receive an inbound emission of electromagnetic radiation as in the case of laser or radar detectors. Further, implementations herein are passive (and not illegal) from the viewpoint of the law enforcement vehicle, alleviating the risk associated with radar jammers. Additionally, implementations provide real-time data and analysis, as compared to crowd-based reporting systems which by definition present old data.

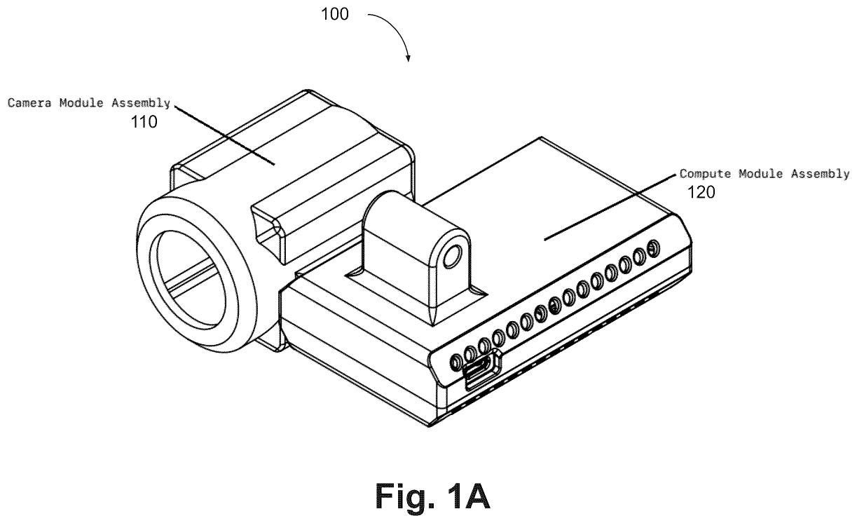

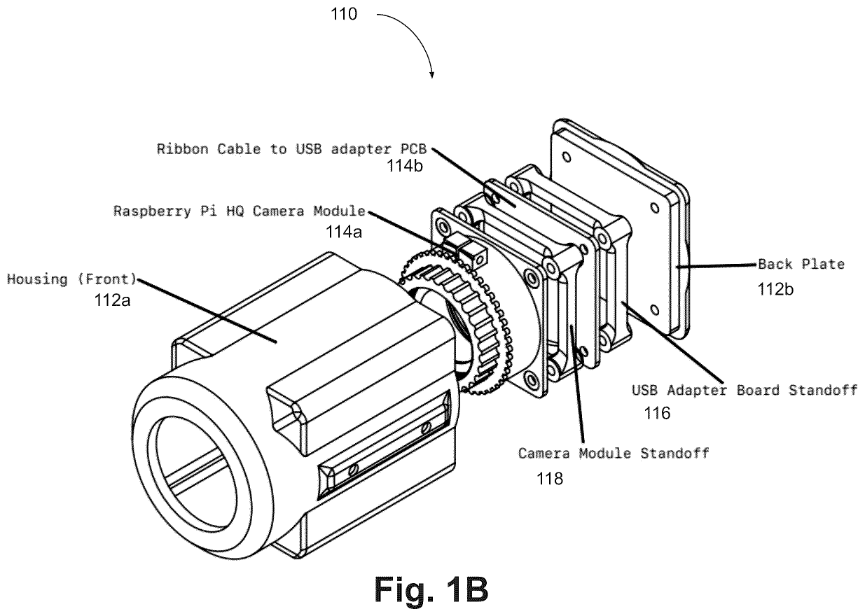

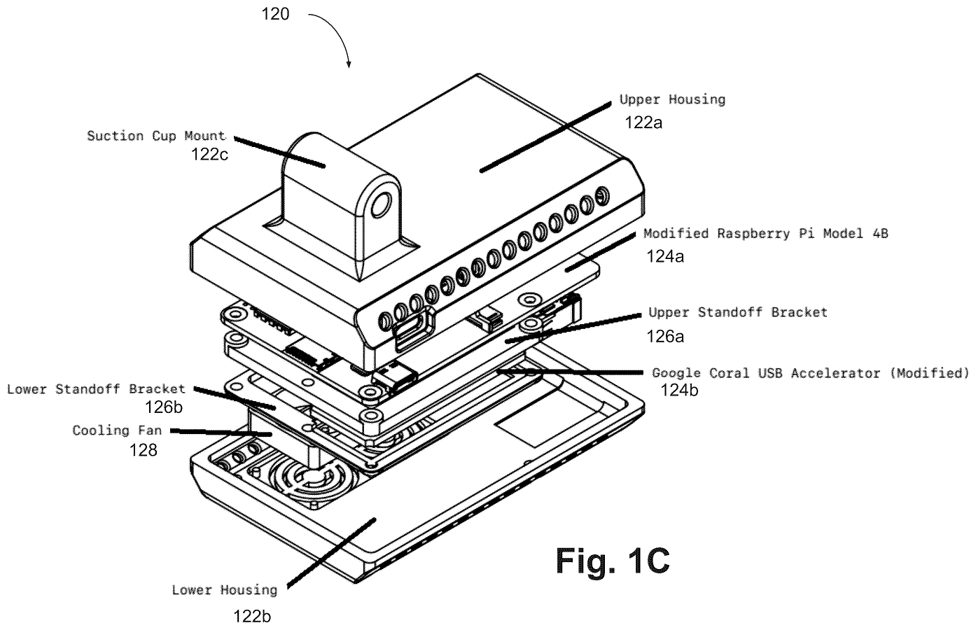

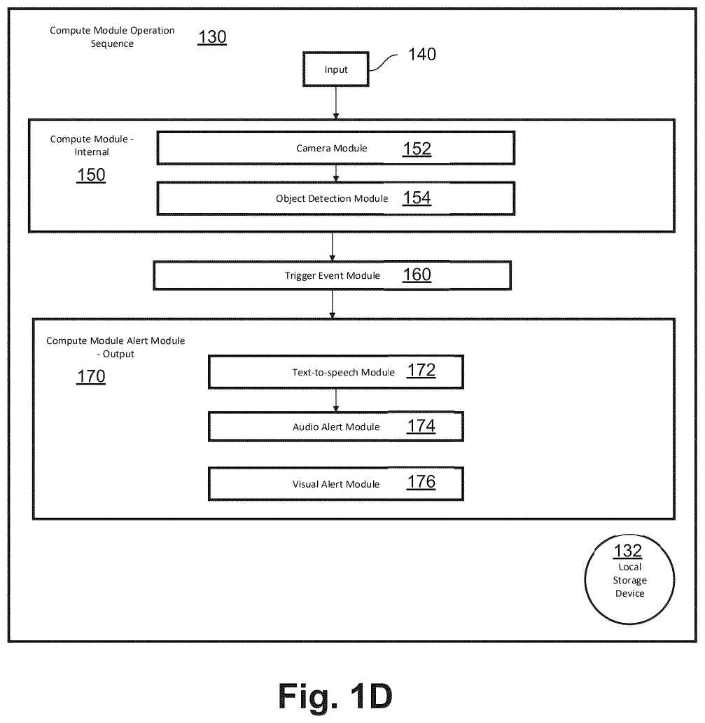

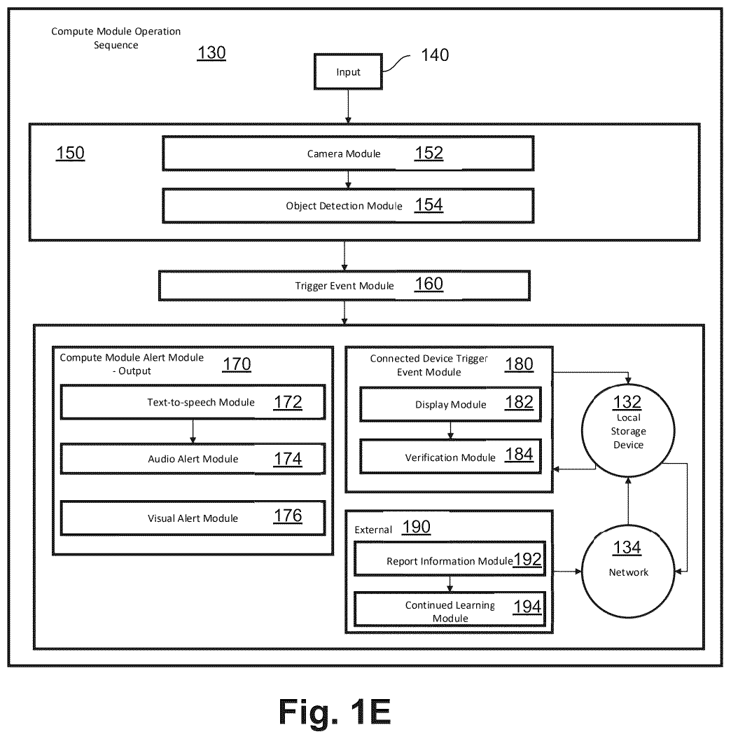

FIG. 1A illustrates an example detection system 100, in accordance with one or more implementations. The detection system 100 may include, for example, a camera assembly 110 and a processor assembly 120. The camera assembly 110 may be in physical and/or electronic communication with the processor assembly 120. The camera assembly 110 and the processor assembly 120 may be configured in such a way as to be mountable, for example, on a dashboard or window of a user vehicle. The camera assembly 110 may function to collect images to be processed by the processor assembly 120.

FIG. 1B illustrates an example camera assembly 110, in accordance with one or more implementations. The camera assembly 110 may include various components necessary for collecting images. The camera assembly 110 may be configured to detect still images and/or a series of images (e.g., video). The camera assembly 110 may include a front housing 112a and a backplate 112b. Contained within the assembly of the front housing 112a and the backplate 112b may be, for example, a camera 114a. The camera 114a may further include a local interface or adapter, such as an adapter 114b configured to transmit and/or convert an electronic signal from the camera 114a to a processor. The various components of the camera assembly 110 may in some implementations require spacing, for example, for cooling reasons. For example, a camera spacer 118 may separate the camera 114a and the adapter 114b. Furthermore, an adapter board spacer 116 may separate the adapter 114b from the backplate 112b.

FIG. 1C illustrates an example processor assembly 120, in accordance with one or more implementations. The processor assembly 120 may include various components configured to enable processing of images and object detection therein, for example, using machine learning.

The processor assembly 120 may include, for example, an upper housing 122a and a lower housing 122b. In some implementations, the upper housing 122a may include, for example, a mount, stand, or bracket for the processor assembly 120 to a point on the vehicle. For example, a suction cup mount 122c (in FIG. 1C, illustrated as integrated with (e.g., monolithic to) the upper housing 122a) may facilitate attachment of a suction cup, which may mount to either a vehicle dashboard or window.

Within the enclosure formed by the upper housing 122a and the lower housing 122b may be various components to facilitate onboard object detections. For example, a computing module 124a may contain a processor and memory having instructions necessary to perform object detection. processor 124a may be, for example, augmented by an accelerator card 124b. There may be spacer brackets, for example, an upper spacer bracket 126a providing space between the processor 124a and the accelerator card 124b, and a lower spacer bracket 126b separating the accelerator card 124b from the lower housing 122b. Since, in some implementations image processing may require significant computing power, and thus significant energy, the components of the processor assembly 120 may need to be cooled, for example, by a cooling fan 128. The cooling fan 128 may be in fluid communication with ducting configured to provide airflow through the processor assembly 120.

FIG. 1D illustrates an example block diagram of a operations sequence 130, in accordance with one or more implementations. The operations sequence 130 may include use of a local storage device 132. The local storage device 132 may be configured to contain the instructions for processing images using a trained machine learning model.

The operations sequence 130 may begin by receiving input at 140 from an image detection device, such as a camera. The input 140 may be provided to a processor 150, which may be internal to a law enforcement vehicle detection system. The internal processor 150 may include a camera 152 and an object detection module 154. The camera 152 may function to process received data from an image sensor, for example, a charge-coupled device (CCD) and convert the same into a digital image format, for example, an image or a video. The object detection module 154 may function to utilize machine learning to determine the presence of given objects, for example, law enforcement vehicles, within the collected images. The object detection module 154 may, for example, implement an artificial neural network (ANN), such as, for example, Tensorflow, to detect the likelihood of presence of particular objects within the image. The ANN may be trained on a series of images along with training indications of the presence of objects within those images. For example, such a system may be trained using various images known to depict law enforcement vehicles, as well as images that do not. The training data may include an indication of which images do and do not correctly contain the object to be detected. The training images may be input into an untrained image detection model, for example, employing an ANN, so that the system can be weighted to facilitate recognition of objects and/or classify images. Such ANNs may include, for example, convolutional neural networks (CNNs) to facilitate rapid and accurate object detection within images.

Object detection may be performed on each frame, or a predetermined interval of frames, received by the object detection module 154. By performing a frame-by-frame analysis, vehicles traveling at speed relative to the vehicle implementing a system or method herein may be detected without being missed.

When the object detection module 154 detects the presence of a law enforcement vehicle within an image, the internal processor 150 may pass an event by a trigger event module 160, which may activate an output alert module 170.

The output alert module 170 may include various modules for alerting a user to the detection of a law enforcement vehicle by the object detection module 154. For example, the output alert module 170 may implement an audio alert module 174, which may interface with an audio output device to issue a sound, for example, a bell or buzzer. In some implementations, audio alert module 174 may provide a text to speech indication of the fact that a law enforcement vehicle was detected and/or a relative location of the law enforcement vehicle. Such text to speech conversation may be performed by a text to speech module 172. Alternatively to an audio alert, the output alert module 170 may provide a visual alert. For example, a light may be lit to indicate the presence of a law enforcement vehicle nearby by interface of a visual alert module 176 with a visual output device or the relative or absolute location of the law enforcement vehicle may be displayed on a screen.

FIG. 1E illustrates an alternative extension to the processor operation sequence 130 illustrated in FIG. 1D, in accordance with one or more implementations. The processor operation sequence 130 of FIG. 1E may include similar operations to those illustrated in FIG. 1D.

In addition to operations discussed in relation to FIG. 1D, the processor operation sequence 130 illustrated in FIG. 1E may include the trigger event module 160 further triggering a connected device trigger event module 180 and/or an external device 190.

The connected device trigger event module 180 may include, for example, a display module 182 and a verification module 184. Such modules may operate on, for example, a remote device such as, for example, a smartphone or tablet. The external device 190 may include, for example, a report information module 192 and a continued learning module 194. The external device 190 may provide for the continued update and training of the overall system, for example, in real-time or via an update program. Feedback from a user, as well as other feedback such as administrator feedback, may be provided to the system to facilitate further training of the machine learning models employed by the object detection module 154. Communication between the onboard device and the external device 190 may be via a network 134. The system may be configured to receive updates via the network 134. Such updates may include, for example, new images, features, or aspects of law enforcement vehicles, which may compose new training data.

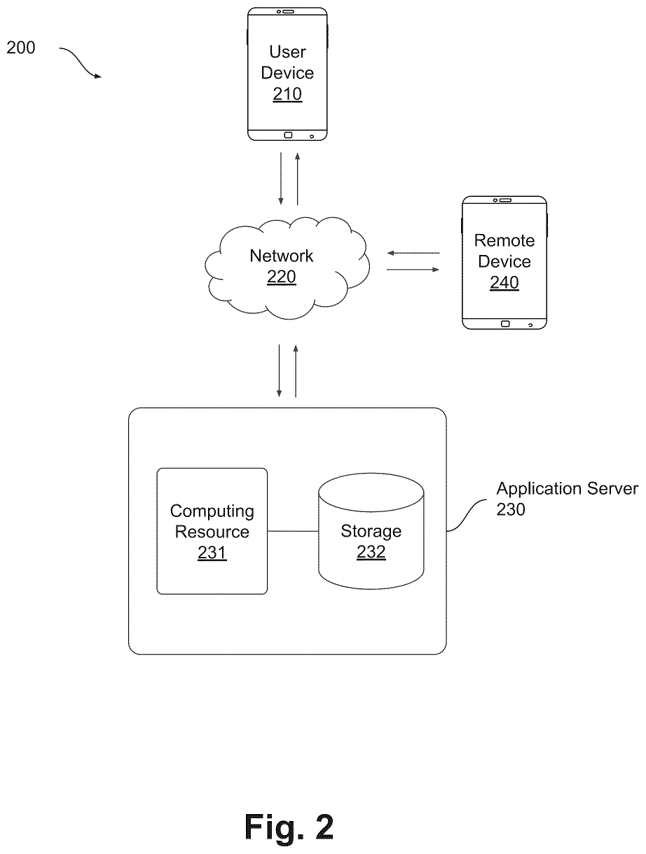

FIG. 2. Illustrates an operational environment 200 for one or more of the implementations herein. As illustrated in FIG. 2, environment 200 may include a user device 210, a network 220, an application server 230 having at least a computing resource 231 and a storage 232, and a remote device 240.

User device 210 may include any variety of devices a user may use to interface with application server 230 via network 220, including, for example, a server, a desktop computer, a laptop computer, a handheld computer, a tablet computing platform, a Netbook, a Smartphone, a gaming console, tablets, wearable devices (e.g., smart watch), AR/VR devices, and/or other computing platforms.

Network 220 may include any variety of devices configured to enable a device communicate with other devices, such as via a wired connection and/or a wireless connection, for example, via the internet and/or other networks using, for example, Transmission Control Protocol/Internet Protocol (TCP/IP) or cellular hardware enabling wired or wireless (e.g., cellular, 2G, 3G, 4G, 4G LTE, 5G, or WIFI®) communication. For example, network 220 may include, inter alia, a receiver, a transmitter, a receiver, a transceiver, a modem, a network interface card, an antenna, or the like.

Application server 230 may include any variety of devices configurable to perform the implementations and methods disclosed herein and interface with user device 210 via network 220, including, for example, a server, a desktop computer, a laptop computer, a handheld computer, a tablet computing platform, a Netbook, a Smartphone, a gaming console, and/or other computing platforms.

Application server 230 may include computing resource 231. Computing resource 231 may include, for example, one or more processor(s) configured to execute machine-readable instructions for implementing all or some of the implementations herein. Computing resource 231 may be configured to access storage 232 to retrieve and/or write electronic data from and to storage 232. Storage 232 may comprise a memory or storage component similar to, for example memory 330 or storage component 340, respectively.

Application server 230 may include storage 232. Storage 232 may be configured to host one or more databases or other forms of data storage for use in implementations herein. Storage 232 may be accessible by computing resource 231.

Remote device 240 may include any variety of devices a user (e.g., a venue agent user) may use to interface with application server 230 via network 220, including, for example, a server, a desktop computer, a laptop computer, a handheld computer, a tablet computing platform, a Netbook, a Smartphone, a gaming console, and/or other computing platforms.

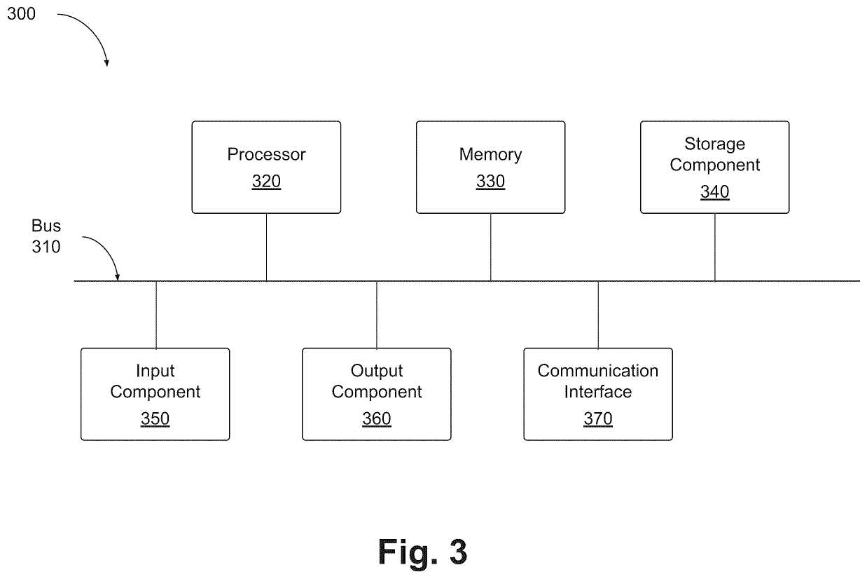

FIG. 3 is a diagram of example components of a device 300, which can correspond to one or more of the device(s), network(s), resource(s), or service(s) of FIG. 2, and/or other device(s) described herein. In some implementations, the device(s), network(s), resource(s), or service(s) of FIG. 2, and/or other devices described herein include one or more devices 300 and/or one or more components of device 300. As shown in FIG. 3, device 300 includes a bus 310, a processor 320, a memory 330, a storage component 340, an input component 350, an output component 360, and a communication interface 370.

Bus 310 includes one or more components that enable wired and/or wireless communication among the components of device 300. Bus 310 couples together two or more components of FIG. 3, such as via operative coupling, communicative coupling, electronic coupling, and/or electric coupling. Processor 320 may take the form of or comprise a central processing unit (CPU), a graphics processing unit (GPU), a microprocessor, a controller, a microcontroller, a digital signal processor, a field-programmable gate array, an application-specific integrated circuit, and/or another type of processing component. In some implementations, processor 320 is implemented in hardware, firmware, or a combination of hardware and software. In some implementations, processor 320 includes one or more processors capable of being programmed to perform one or more operations or processes described elsewhere herein.

Memory 330 includes volatile and/or nonvolatile memory. For example, memory 330 includes random access memory (RAM), read only memory (ROM), a hard disk drive, and/or another type of memory (e.g., a flash memory, a magnetic memory, and/or an optical memory). Memory 330 includes internal memory (e.g., RAM, ROM, or a hard disk drive) and/or removable memory (e.g., removable via a universal serial bus connection). Memory 330 is a non-transitory computer-readable medium. Memory 330 stores information, instructions, and/or software (e.g., one or more software applications) related to the operation of device 300. In some implementations, memory 330 includes one or more memories that are coupled to one or more processors (e.g., processor 320), such as via bus 310.

Storage component 340 stores information and/or software related to the operation of device 300. For example, storage component 340 may include a hard disk drive, a magnetic disk drive, an optical disk drive, a solid-state disk drive, a compact disc, a digital versatile disc, and/or another type of non-transitory computer-readable medium. Implementations of storage component 340 may include one or more of optically readable storage media (e.g., optical disks, etc.), magnetically readable storage media (e.g., magnetic tape, magnetic hard drive, floppy drive, etc.), electrical charge-based storage media (e.g., electrically erasable programmable read-only memory (EEPROM), random access memory (RAM), etc.), solid-state storage media (e.g., flash drive, etc.), and/or other electronically readable storage media. Implementations of storage component 340 may include one or both of system storage provided integrally (i.e., substantially non-removable) to device 300 and/or removable storage that is removably connectable to device 300 via, for example, a port (e.g., a USB port, an IEEE 1394 port, a THUNDERBOLT™ port, etc.) or a drive (e.g., disk drive, flash drive, or solid-state drive etc.). Storage component 340 may also or alternatively include one or more virtual storage resources (e.g., cloud storage, a virtual private network, and/or other virtual storage resources). Storage component 340 may store software algorithms, information determined by one or more processors, information received from one or more computing platforms, information received from one or more remote platforms, databases (e.g., structured query language (SQL) databases (e.g., MYSQL®, MARIADB®, MONGODB®), NO-SQL databases, among others), and/or other information enabling a computing platform to function as described herein.

Input component 350 enables device 300 to receive input, such as user input and/or sensed input. For example, input component 350 includes a touch screen, a keyboard, a keypad, a mouse, a button, a microphone, a switch, a sensor, a global positioning system sensor, an accelerometer, a gyroscope, and/or an actuator. Output component 360 enables device 300 to provide output, such as via a display, a speaker, and/or a light-emitting diode. Communication interface 370 enables device 300 to communicate with other devices via a wired connection and/or a wireless connection. For example, communication interface 370 includes a receiver, a transmitter, a transceiver, a modem, a network interface card, and/or an antenna.

Device 300 performs one or more operations or processes described herein. For example, a non-transitory computer-readable medium (e.g., memory 330) stores a set of instructions (e.g., one or more instructions or code) for execution by processor 320. Processor 320 can execute the set of instructions to perform one or more operations or processes described herein. In some implementations, execution of the set of instructions, by one or more processors 320, causes the one or more processors 320 and/or the device 300 to perform one or more operations or processes described herein. In some implementations, hardwired circuitry is used instead of or in combination with the instructions to perform one or more operations or processes described herein. Additionally, or alternatively, processor 320 can be configured to perform one or more operations or processes described herein. Thus, implementations described herein are not limited to any specific combination of hardware circuitry and software.

The number and arrangement of components shown in FIG. 3 are provided as an example. Device 300 includes additional components, fewer components, different components, or differently arranged components than those shown in FIG. 3. Additionally, or alternatively, a set of components (e.g., one or more components) of device 300 can perform one or more functions described as being performed by another set of components of device 300.

Implementations may implement machine learning, a type of artificial intelligence (AI) that provides computers with an ability to learn how to process data without being explicitly programmed. Machine learning focuses on the development of computer programs that can teach themselves to grow and change when exposed to new data. Machine learning explores the study and construction of algorithms that can learn from and make predictions based on data. Such algorithms may overcome following strictly static program instructions by making data-driven predictions or decisions, through building a model from sample inputs.

Machine learning may refer to a variety of AI software algorithms, which may be used to perform supervised learning, unsupervised learning, reinforcement learning, deep learning, or any combination thereof. A variety of different machine learning algorithms may be employed in implementations. Examples of machine learning algorithms may include, inter alia, artificial neural network algorithms, Gaussian process regression algorithms, fuzzy logic-based algorithms, or decision tree algorithms.

In some implementations, more than one machine learning algorithm may be employed. For example, automated classification may be implemented using one type of machine learning algorithm, and adaptive real-time process control may be implemented using a different type of machine learning algorithm. In some implementations, hybrid machine learning algorithms including features and properties drawn from two, three, four, five, or more different types of machine learning algorithms may be employed in implementations.

Supervised learning algorithms may use labeled training data to infer a relationship between one or more identifiable aspects of a given entity and a classification of the entity according to a specified set of criteria or to infer a relationship between input process control parameters and desired outcomes. The training data may include paired training examples. For example, each training data example may include aspects identified for a given entity and the resultant classification of the given entity. As a further example, each training data example may include process control parameters used in a process and a known outcome of the process.

Unsupervised learning algorithms may be used to draw inferences from training data including entity data not paired with labeled entity classification data, or input process control parameter data not paired with labeled process outcomes. An example unsupervised learning algorithm is cluster analysis, which may be used for exploratory data analysis to find hidden patterns or groupings in process data.

Semi-supervised learning algorithms may use both labeled and unlabeled object classification or process data for training. Semi-supervised learning algorithms may typically use a small amount of labeled data with a large amount of unlabeled data.

Reinforcement learning algorithms may be used, for example, to optimize a process (e.g., steps or actions of the process) to maximize a process reward function or minimize a process loss function. In machine learning environments, reinforcement learning algorithms may be formulated, e.g., a Markov decision processes. Reward functions or loss functions, which may also be referred to as cost functions or error functions, may map values of one or more process variables and/or outcomes to a real number that represents a reward or cost, respectively, associated with a given process outcome or event. Examples of process parameters and process outcomes include, inter alia, process throughput, process yield, production quality, or production cost. In some cases, the definition of the reward or loss function to be maximized or minimized, respectively, may depend on the choice of machine learning algorithm used to run the process control method, or vice versa. For example, if an objective is to maximize a total reward/value function, a reinforcement learning algorithm may be chosen. If the objective is to minimize a mean-squared-error loss function, a decision-tree regression algorithm or linear-regression algorithm may be chosen. In general, the machine learning algorithm used to run the process control method optimizes the reward function or minimize the loss function by identifying the current state of the process; comparing the current state to the reference state, which may be a target intermediate or final state; and adjusting one or more process control parameters to minimize a difference between the two states. This adjustment may include reference to past learning provided by a training data set. Reinforcement-learning algorithms differ from supervised learning algorithms in that correct training data input/output pairs are not presented, nor are sub-optimal actions explicitly corrected. Implementations of these algorithms tend to focus on real-time performance by finding a balance between exploration of possible outcomes based on updated input data and exploitation of past training.

Deep learning, commonly known as deep structured learning, hierarchical learning, or deep machine learning, implements a set of algorithms that attempt to model high level abstractions in data sets. Deep learning models implemented herein process information such as image, text, or sound information in a hierarchical manner. An observation (defined as a feature to be extracted for reference) can be represented in many ways including, for example, a vector of intensity values, a set of edges, regions of shape, or in another abstract manner. Some representations may simplify the learning task (e.g., face recognition or facial expression recognition). Deep learning may provide efficient algorithms for unsupervised or semi-supervised feature learning and hierarchical feature extraction. implementations employing deep learning can further benefit from the advantage of deep learning concepts in solving a normally intractable representation inversion problem.

A deep learning module may be configured as a neural network. The deep learning module may further be a deep neural network with a set of weights that model the world based on training using training data. Neural networks can be understood to implement a computational approach—based on a relatively large collection of neural units—to loosely model the way a human brain solves problems with large clusters of biological neurons connected by axons. Each neural unit may be connected to one or more others, and links can be enforcing or inhibitory in their effect on the activation state of connected neural units. These systems may be self-learning and trained rather than explicitly programmed. Neural network systems excel in areas where a solution or feature detection is difficult to express in a traditional computer program.

An example of a deep learning algorithm may be an artificial neural network (ANN). Large ANNs including many layers may be used, for example, to map entity data to entity classification decisions or to map input process control parameters to desired process outcomes. ANNs will be discussed in further detail below.

Neural networks typically include multiple layers, and the signal path may traverse from front to back. The goal of neural networks may be to solve problems in a similar manner to the human brain, although several neural networks may be much more abstract. In a simple example of a neural network, there may be two layers (i.e., sets) of neurons: an input layer that receives an input signal and an output layer that sends an output signal. When the input layer receives an input, it may pass a modified version of the input to the next layer. In a deep network, there may be many layers between the input layer and output layer, allowing the algorithm to use multiple processing layers, which may include multiple linear and non-linear transformations.

There are many variants of neural networks with deep architecture depending on the probability specification and network architecture, including, inter alia, deep belief networks (DBN), restricted Boltzmann machines (RBM), random forests, and autoencoders. Implementations of neural networks may vary depending on the size of input data, the number of features to be analyzed, and the nature of the problem. Other layers may be included in the deep learning module besides the neural networks disclosed herein.

Another type of deep neural network may be a convolutional neural network (CNN), which can be used for analysis of an entity or process. CNNs are commonly composed of layers of different types: convolution, pooling, upscaling, and fully connected layers. In some cases, an activation function such as a rectified linear unit (ReLU) function may be used in some of the layers. In a CNN architecture, there can be one or more layers for each type of operation performed. A CNN architecture may include any number of layers in total, and any number of layers for the different types of operations performed. The simplest CNN architecture starts with an input layer followed by a sequence of convolutional layers and pooling layers (e.g., layers otherwise configured for reducing the dimensionality of the feature map generated by the one or more convolutional layers while retaining the most important features, for example, max pooling layers) and ends with fully connected layers (e.g., a layer in which each of the nodes is connected to each of the nodes in the previous layer). Each convolution layer may include a plurality of parameters used for performing the convolution operations. Each convolution layer may also include one or more filters, which in turn may include one or more weighting factors or other adjustable parameters. In some instances, the parameters may include biases (e.g., parameters that permit an activation function to be shifted). In some cases, the convolutional layers may be followed by an ReLU activation function layer. Other activation functions can also be used, for example, inter alia, saturating hyperbolic tangent, identity, binary step, logistic, arctan, softsign, parametric rectified linear unit, exponential linear unit, softPlus, bent identity, softExponential, Sinusoid, Sinc, Gaussian, or sigmoid functions. The convolutional, pooling and ReLU layers may function as learnable feature extractors, while the fully connected layers may function as machine learning classifiers. As with other artificial neural networks, the convolutional layers and fully connected layers of CNN architectures may include various computational parameters, for example, weights, bias values, and threshold values, which may be trained in a training phase.

Another type of deep neural network may be a visual geometry group (VGG) network. For example, VGG networks may be created by increasing the number of convolutional layers while fixing other parameters of the architecture. Adding convolutional layers to increase depth may be made possible by using substantially small convolutional filters in all of the layers. VGG networks may also include convolutional layers followed by fully connected layers.

Another type of deep neural network may be a deep residual network. Like some other networks described herein, a deep residual network may include convolutional layers followed by fully connected layers, which may be, in combination, configured and trained for feature property extraction. A deep residual network's layers may be configured to learn residual functions with reference to layer inputs, instead of learning unreferenced functions. Instead of relying on a direct fit of few stacked layers to a desired underlying mapping, a deep residual network's layers may be explicitly allowed to fit a residual mapping, which may be realized by feedforward neural networks having shortcut connections (i.e., connections that skip one or more layers). A deep residual network may be created by inserting shortcut connections into a plain neural network structure including convolutional layers, thereby modifying the plain neural network into a residual learning network.

In some implementations, the machine learning module may include a support vector machine (SVM), an artificial neural network (ANN), a decision tree-based expert learning system, an autoencoder, a clustering machine learning algorithm, or a nearest neighbor (e.g., kNN) machine learning algorithm, or combinations thereof, some of which will be described in further detail below.

Support vector machines (SVMs) may be supervised learning algorithms used for classification and regression analysis of entity classification data or process control. Given a set of training data examples (e.g., entity or process data), each marked as belonging to a category, an SVM training algorithm may build a model that assigns new examples (e.g., data from a new entity or process) to a given category.

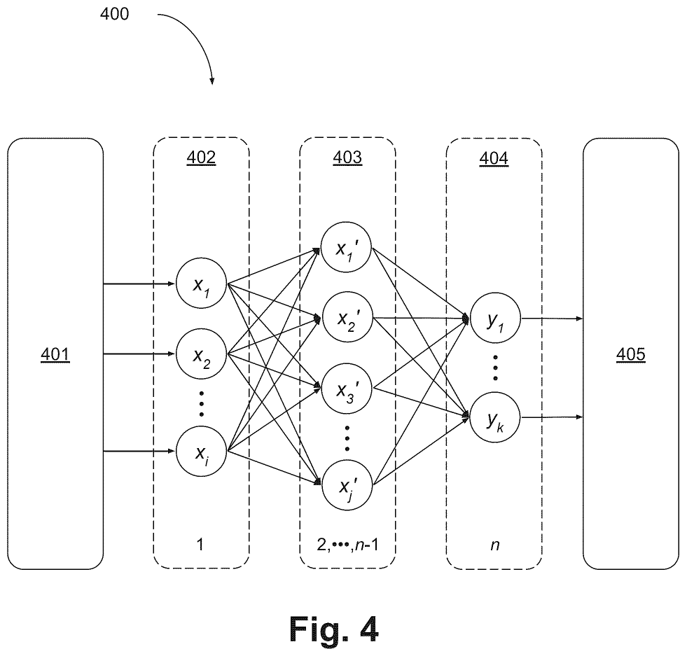

FIG. 4 illustrates an artificial neural network (ANN) 400, according to an implementation. ANN 400 may be used for, inter alia, classification or process control optimization according to various implementations.

ANN 400 may include any type of neural network module, such as, inter alia, a feedforward neural network, radial basis function network, recurrent neural network, or convolutional neural network.

In implementations implementing ANN 400 for entity classification, ANN 400 may be employed to map entity data to entity classification data. In implementations implementing ANN 400 for process optimization, ANN 400 may be employed to determine an optimal set or sequence of process control parameter settings for adaptive control of a process in real-time based on a stream of process monitoring data and/or entity classification data provided by, for example, observation or from one or more sensors. ANN 400 may include an untrained ANN, a trained ANN, pre-trained ANN, a continuously updated ANN (e.g., an ANN utilizing training data that is continuously updated with real-time classification data or process control and monitoring data from a single local system, from a plurality of local systems, or from a plurality of geographically distributed systems).

ANN 400 may include interconnected nodes (e.g., x₁-xᵢ, x₁′-xⱼ′, and y₁-yₖ) organized into n layers of nodes, where x₁-xᵢ represents a group of i nodes in a first layer 402 (e.g., layer 1), x₁′-xⱼ′ represents a group of j nodes in a hidden layer 403 (e.g., layer(s) 2 through n−1), and y₁-yₖ represents a group of k nodes in a final layer 404 (e.g., layer n). Input layer 402 may be configured to receive input data 401 (e.g., sensor data, image data, sound data, observed data, automatically retrieved data, manually input data, etc.). Final layer 404 may be configured to provide result data 405.

There may be one or multiple hidden layers 403, and the number j of nodes in each hidden layer 403 may vary from implementation to implementation. Thus, ANN 400 may include any total number of layers (e.g., any number of hidden layers 403). One or more of hidden layers 403 may function as trainable feature extractors, which may allow mapping of input data 401 to preferred result data 405.

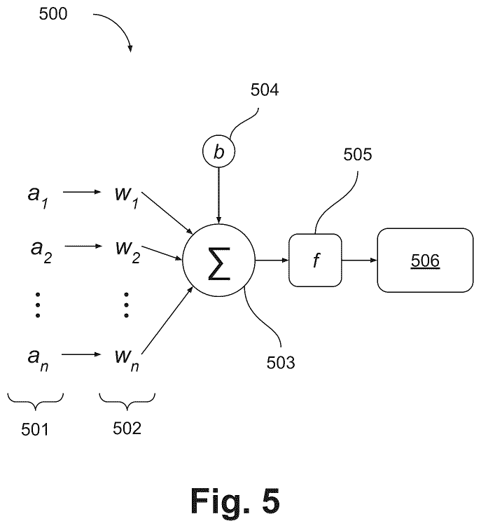

FIG. 5 illustrates a node 500, according to an implementation. Each layer of a neural network may include one or more nodes similar to node 500, for example, nodes x₁-xᵢ, x₁-xⱼ′, and y₁-yₖ depicted in FIG. 4. Each node may be analogous to a biological neuron.

Node 500 may receive node inputs 501 (e.g., a₁-aₙ) either directly from the ANN's input data (e.g., input data 401) or from the output of one or more nodes in a different layer or the same layer. With node inputs 501, the node 500 may perform an operation 503, which while depicted in FIG. 5 as a summation operation, would be readily understood to include various other operations known in the art.

In some cases, node inputs 501 may be associated with one or more weights 502 (e.g., w₁-wₙ), which may represent weighting factors. For example, operation 503 may sum the products of each of node inputs 501 and associated weights 502 (e.g., aᵢwᵢ).

The result of operation 503 may be offset with a bias 504 (e.g., bias b), which may be a value or a function.

Output 506 of node 500 may be gated using an activation (or threshold) function 505 (e.g., function f), which may be a linear or a nonlinear function. Activation function 505 may be, for example, a ReLU activation function or other function such as a saturating hyperbolic tangent, identity, binary step, logistic, arctan, softsign, parametric rectified linear unit, exponential linear unit, softPlus, bent identity, softExponential, Sinusoid, Sinc, Gaussian, or sigmoid function, or any combination thereof.

Weights 502, biases 504, or threshold values of activation functions 505, or other computational parameters of the neural network, can be “taught” or “learned” in a training phase using one or more sets of training data. For example, the parameters may be trained using input data from a training data set and a gradient descent or backward propagation method so that the output value(s) (e.g., a set of predicted adjustments to classification or process control parameter settings) computed by the ANN may be consistent with the examples included in the training data set. The parameters may be obtained, for example, from a back propagation neural network training process, which may or may not be performed using the same hardware as that used for automated classification or adaptive, real-time deposition process control. Decision tree-based expert systems may be supervised learning algorithms designed to solve entity classification problems or process control problems by applying a series of conditional (e.g., if-then) rules. Expert systems may include two subsystems: an inference engine and a knowledge base. The knowledge base may include a set of facts (e.g., a training data set including entity data for a series of entities, and the associated entity classification data provided by, for example, a skilled operator, technician, or inspector) and derived rules (e.g., derived entity classification rules). The inference engine may then apply the rules to input data for a current entity classification problem or process control problem to determine a classification of the entity or a next set of process control adjustments.

Autoencoders (also sometimes referred to as an auto-associator or Diabolo network), may be an ANN used for unsupervised and efficient mapping of input data (e.g., entity data or process data), to an output value (e.g., an entity classification or optimized process control parameters). Autoencoders may be used for the purpose of dimensionality reduction, that is, a process of reducing the number of random variables under consideration by deducing a set of principal component variables. Dimensionality reduction may be performed, for example, for the purpose of feature selection (e.g., selecting a subset of the original variables) or feature extraction (e.g., transforming of data in a high-dimensional space to a space of fewer dimensions).

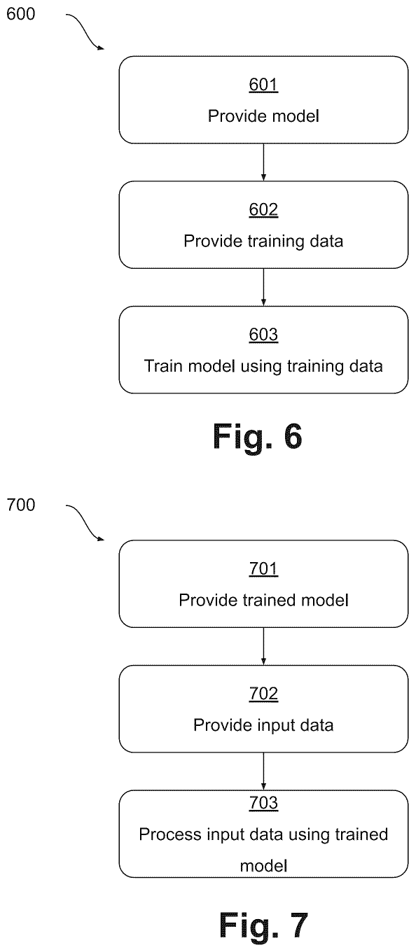

FIG. 6 illustrates a method 600 of training a machine learning model of a machine learning module, according to an implementation. Use of method 600 may provide for use of training data to train a machine learning model for concurrent or later use.

At 601, a machine learning model including one or more machine learning algorithms may be received.

At 602, training data may be received. Training data may include one or more of process simulation data, process characterization data, in-process or post-process inspection data (including inspection data provided by a skilled operator and/or inspection data provided by any of a variety of automated inspection tools), or any combination thereof, for past processes that are the same as or different from that of the current process. One or more sets of training data may be used to train the machine learning algorithm used for object defect detection and classification. In some cases, the type of data included in the training data set may vary depending on the specific type of machine learning algorithm employed.

At 603, the machine learning model may be trained using the training data. For example, training the model may include inputting the training data to the machine learning model and modifying one or more parameters of the model until the output of the model is the same as (or substantially the same as) external validation data. Model training may generate one or more trained models. One or more trained models may be selected for further validation or deployment, which may be performed using validation data. The results produced by each trained model for the validation data input to the training model may be compared to the validation data to determine which of the models is the best model. For example, the trained model that produces results most closely matching the validation data may be selected as the best model. Test data may then be used to evaluate the selected model. The selected model may also be sent to model deployment in which the best model may be sent to the processor for use in a post-training mode.

FIG. 7 illustrates a method 700 of analyzing input data using a machine learning module, according to an implementation. Use of the machine learning module described by method 700 may enable, for example, automatic classification of an entity or optimized process control.

At 701, a trained machine learning model may be provided to the machine learning module. The trained machine learning model may have been trained, or under continuous or periodic training by one or more other systems or methods. The machine learning model may be pre-generated and trained, enabling functionality of the module as described herein, which can then be used to perform one or more post-training functions of the machine learning module.

For example, the provided trained machine learning model may be similar to ANN 400, include nodes similar to node 500, and may have been trained (or be under continuous or periodic training) using a method similar to method 600.

At 702, input data may be provided to the machine learning module for input into the machine learning model. The input data may result from or be derived from a variety of different sources, similar to input data 401.

The provision of input data at 702 may further include removing noise from the data prior to providing it to the machine learning algorithm. Examples of data processing algorithms suitable for use in removing noise from the input data may include, inter alia, signal averaging algorithms, smoothing filter algorithms, Kalman filter algorithms, nonlinear filter algorithms, total variation minimization algorithms, or any combination thereof.

The provision of input data at 702 may further include subtraction of a reference data set from the input data to increase contrast between aspects of interest of an entity or process and those not of interest, thereby facilitating classification or process control optimization. For example, a reference data set may include input data for a real or contrived ideal example of the entity or process. If an image sensor or machine vision system is used for entity observation, the reference data set may include an image or set of images (e.g., representing different views) of an ideal entity.

At 703, the machine learning module may process the input data using the trained machine learning model to yield results from the machine learning module. Such results may include, for example, an entity classification or one or more optimized process control parameters.

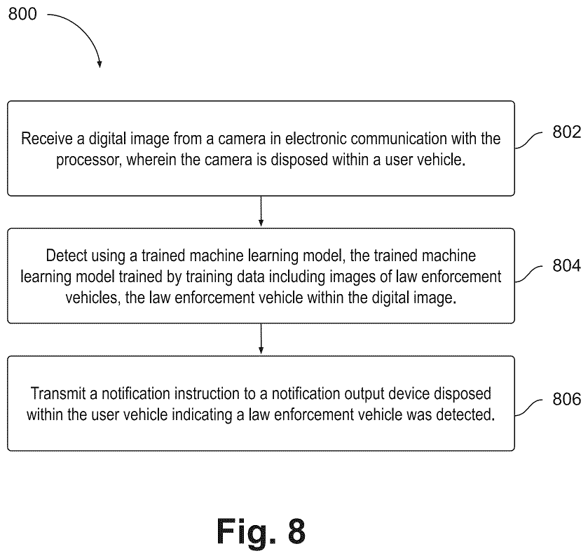

FIG. 8 is a flow chart of an example method 800 for detecting a law enforcement vehicle, in accordance with one or more implementations. In some implementations, one or more steps of FIG. 8 are performed by a device including one or more of the devices illustrated in FIG. 2, and/or other devices. In some implementations, one or more steps of FIG. 8 are performed by another device or a group of devices separate from or including the device.

As shown at step 802, the method 800 may include receiving a digital image from a camera, which may be in electronic communication with a processor. The camera may be disposed within a user vehicle.

As shown at step 804, the method 800 may include detecting, using a trained machine learning model, the law enforcement vehicle within the digital image. The trained machine learning model may be trained by training data including images of law enforcement vehicles. The method 800 may further include training an untrained machine learning model by the training data, which may include images of law enforcement vehicles, which may yield the machine learning model.

As shown at step 806 the method 800 may include transmitting a notification instruction to a notification output device. The notification output device may be disposed within the user vehicle, and may indicate a law enforcement vehicle was detected.

The processor, the camera, and the notification output device may be disposed within a housing. The housing may include a mounting device, which may be configured to secure the housing to the dashboard to a user vehicle.

The processor, the camera, or the notification output device may be integrated into the user vehicle.

The notification output device may be a light device. The notification instruction may include a computer instruction to emit light from a light device. The notification output device may include a speaker.

The notification instruction may include a computer instruction to emit a sound from the speaker. The sound may be a generated voice statement, which may indicate a location of the law enforcement vehicle relative to the user vehicle.

The notification output device may include a display, which may be configured to display a map. The notification instruction may include a computer instruction to display a location of the law enforcement vehicle on the map.

The notification output device may include a mobile device. Transmitting the notification instruction to the notification output device may include transmitting a communications signal to the notifications output device via electronic communications, for example, via a networking device.

Method 800 includes additional implementations, such as any single implementation or any combination of implementations described herein and/or in connection with one or more other methods or processes described elsewhere herein.

Although FIG. 8 shows example blocks of method 800, in some implementations, method 800 includes additional blocks, fewer blocks, different blocks, or differently arranged blocks than those depicted in FIG. 8. Additionally, or alternatively, two or more of the blocks of method 800 can be performed in parallel.

The foregoing disclosure provides illustration and description but is not intended to be exhaustive or to limit the implementations to the precise form disclosed. Modifications and variations can be made in light of the above disclosure or can be acquired from practice of the implementations.

As used herein, the terms “component” or “module” are intended to be broadly construed as hardware, firmware, or a combination of hardware and software.

It will be apparent that systems and/or methods described herein can be implemented in different forms of hardware, firmware, or a combination of hardware and software. The actual specialized control hardware or software code used to implement these systems and/or methods is not limiting of the implementations. Thus, the operation and behavior of the systems and/or methods are described herein without reference to specific software code—it being understood that software and hardware can be designed to implement the systems and/or methods based on the description herein.

Even though particular combinations of features are recited in the claims and/or disclosed in the specification, these combinations are not intended to limit the disclosure of various implementations. In fact, many of these features can be combined in ways not specifically recited in the claims and/or disclosed in the specification. Although each dependent claim listed below can directly depend on only one claim, the disclosure of various implementations includes each dependent claim in combination with every other claim in the claim set.

What is claimed is:

1. A method in a data processing system for detecting a law enforcement vehicle, the method comprising, using a processor of the data processing system:
receiving a digital image, at the processor, from a camera in electronic communication with the processor, wherein the camera is disposed within a user vehicle;
detecting the law enforcement vehicle within the digital image by the processor using a machine learning model, the machine learning model trained by training data including images of law enforcement vehicles; and
transmitting, by the processor, a notification instruction to a notification output device disposed within the user vehicle indicating the law enforcement vehicle was detected.

2. The method of claim 1, wherein the processor, the camera, and the notification output device are disposed within a housing.

3. The method of claim 2, wherein the housing includes a mounting device configured to secure the housing to a dashboard of the user vehicle.

4. The method of claim 1, further comprising training the machine learning model by the training data including images of law enforcement vehicles.

5. The method of claim 1, wherein the processor, the camera, or the notification output device is integrated into the user vehicle.

6. The method of claim 1, wherein the notification output device is a light device, and the notification instruction includes a computer instruction to emit light from the light device.

7. The method of claim 1, wherein the notification output device includes a speaker, and the notification instruction includes a computer instruction to emit a sound from the speaker.

8. The method of claim 7, wherein the sound is a generated voice statement indicating a location of the law enforcement vehicle relative to the user vehicle.

9. The method of claim 1, wherein the notification output device includes a display configured to display a map, and the notification instruction includes a computer instruction to display a location of the law enforcement vehicle on the map.

10. The method of claim 1, wherein the notification output device includes a mobile device, and transmitting the notification instruction to the notification output device includes transmitting a communications signal to the notification output device via a networking device.

11. A computing system configured for detecting a law enforcement vehicle, the computing system comprising:
a memory having executable instructions;
a camera;
a notification output device; and
one or more processors configured to execute the instructions to:
receive a digital image, from the camera, wherein the camera is disposed within a user vehicle;
detect the law enforcement vehicle within the digital image using a machine learning model, the machine learning model trained by training data including images of law enforcement vehicles; and
transmit a notification instruction to the notification output device indicating the law enforcement vehicle was detected.

12. The computing system of claim 11, wherein the processor, the camera, and the notification output device are disposed within a housing.

13. The computing system of claim 12, wherein the housing includes a mounting device configured to secure the housing to a dashboard of the user vehicle.

14. The computing system of claim 11, wherein the one or more processor is further configured to execute instructions to train the machine learning model by the training data including images of law enforcement vehicles.

15. The computing system of claim 11, wherein the processor, the camera, or the notification output device is integrated into the user vehicle.

16. The computing system of claim 11, wherein the notification output device is a light device, and the notification instruction includes a computer instruction to emit light from the light device.

17. The computing system of claim 11, wherein the notification output device includes a speaker, and the notification instruction includes a computer instruction to emit a sound from the speaker.

18. The computing system of claim 17, wherein the sound is a generated voice statement indicating a location of the law enforcement vehicle relative to the vehicle.

19. The computing system of claim 11, wherein the notification output device includes a display configured to display a map, and the notification instruction includes a computer instruction to display a location of the law enforcement vehicle on the map.

20. The computing system of claim 11, wherein the notification output device includes a mobile device, and transmitting the notification instruction to the notification output device includes transmitting a communications signal to the notification output device via a networking device.
